(19) United States
(12) Patent Application Publication
(10) Pub. No.: US 2008/0264793 A1
(43) Pub. Date: Oct. 30, 2008

(54) Hydrolytically Stable Isoelectric Hydrogel Compositions

(76) Inventors: Gyula Vigh, College Station, TX (US); Sanjiv Kumar S. Lalwani, College Station, TX (US)

Correspondence Address: COOLEY GODWARD KRONISH LLP;ATTN: Patent Group, Suite 1100, 777 - 6th Street, NW, WASHINGTON, DC, 20001, US

(21) Appl. No.: 10/567,743

(22) PCT Filed: Aug. 13, 2004
(86) PCT No.: PCT/US04/26378

§ 371 Date: Aug. 21, 2007

Related U.S. Application Data
(60) Provisional application No. 60/495,086, filed on Aug. 15, 2003.

(51) Int. Cl. B01D 59/42

(52) U.S. Cl. 204/518; 252/500

(57) ABSTRACT

An hydrolytically stable isoelectric hydrogel material comprising a single isoelectric compound having a defined pI value from 1 to 12 being incorporated into a hydrogel formed by reacting an oligo- or polyhydroxy compound with the single iso-electric compound and a difunctional or oligofunctional crosslinker, wherein after incorporation of the single isoelectric compound into the hydrogel, the hydrogel material become's an ampholytic material.

### TECHNICAL FIELD

The invention relates to hydrolytically stable isoelectric hydrogel and/or membrane compositions. The primary application areas of the new hydrolytically stable hydrogel and/or membrane compositions are in the analytical and preparative-scale isoelectric focusing separation and/or isoelectric trapping separation of compounds.

### BACKGROUND

Electrophoretic techniques, and isoelectric focusing (IEF) techniques in particular, remain key technologies for the separation of ampholytic components, small and large, simple and complex alike. Used in many fields and industries, IEF is performed both on an analytical and preparative scale. For example, IEF is utilized in clinical diagnosis, biotechnology, pharmaceutical and food industries, alone or coupled with other analytical or preparative techniques.

In IEF, ampholytic components are separated with the help of an electric field in a pH gradient wherein the pH increases from a selected pH value at the anode to a higher pH value at the cathode. (For a monograph on IEF, see, e.g., P. G. Righetti, Isoelectric focusing: theory, methodology and applications, Elsevier Biomedical, Amsterdam, 1983, which is herein incorporated by reference). As the net charge of an ampholytic component is zero in its isoelectric state, the electrophoretic migration velocity of an ampholytic component becomes zero whenever the pH of its environment becomes equal to its isoelectric point (pI) value. Thus, ampholytic components with different pI values stop migrating at different points in the pH gradient.

Relatively stable continuous pH gradients can be created by several means. For example, mixtures of carrier ampholytes (compounds that have adequate buffering ability and conductivity in the vicinity of their pI value) may be used. Alternatively, appropriate amounts of suitable weak acids and weak bases or weak acids and strong bases or strong acids and weak bases may be bound into an ion-permeable matrix, such as a cross-linked polyacrylamide gel to preform the pH gradient which is then used for immobilized pH gradient IEF (IPGIEF). (For a monograph on IPGEF, see, e.g., P. G. Righetti, Immobilized pH gradients: theory and methodology, Elsevier, Amsterdam, 1990, which is herein incorporated by reference).

Alternatively, ampholytic sample components can also be separated from each other by isoelectric trapping (IET) utilizing isoelectric membrane-based multicompartmental electrolyzers (e.g., Martin et al., U.S. Pat. No. 4,243,507 and Faupel et al., U.S. Pat. No. 5,082,548, which is incorporated herein by reference) wherein at the end of an IET separation process, ampholytic sample components can be obtained in their pure, isoelectric state.

Unfortunately, the present IEF or IET technologies are not particularly suitable for the separation or processing of compounds having low or high pI values as the separation media presently employed are not particularly stable at extreme pH values. Furthermore, the pI values of the currently used isoelectric hydrogels and/or membranes, such as Immobiline chemicals-based acrylamide hydrogels and membranes and cellulose-based isoelectric hydrogels and/or membranes obtained by reacting the polysaccharide by an appropriate weak acid and a weak or strong base or and appropriate weak base and weak or strong acid, vary unpredictably due to the incomplete and unpredictable incorporation rates of the required at least two Immobiline chemicals and the required at least two derivatizing weak acids, strong acids, weak bases and strong bases. Thus, there is a real need for hydrolytically stable and high buffering capacity hydrogel and/or membrane compositions whose pI values are not subject to these unpredictable, untoward variations.

The present inventors have now developed useful hydrolytically stable hydrogel and/or membrane compositions

### SUMMARY OF INVENTION

In a first aspect, the present invention provides an hydrolytically stable isoelectric hydrogel material comprising a single isoelectric compound having a defined pI value being incorporated into a hydrogel formed by reacting an oligo- or polyhydroxy compound with the single isoelectric compound and a difunctional or oligofunctional crosslinker, wherein after incorporation of the single isoelectric compound into the hydrogel, the hydrogel material becomes an ampholytic material.

In a second aspect, the present invention provides an hydrolytically stable isoelectric hydrogel material comprising a single isoelectric compound having a defined pI being incorporated into and/or grafted onto a suitable oligomeric or polymeric scaffold that can be subsequently turned into an hydrogel and/or a membrane, wherein after incorporation of the single isoelectric compound the hydrogel material becomes an ampholytic material.

In one preferred form, the resultant hydrogel material has a pI value which does not substantially change when the extent of incorporation of the single isoelectric compound is altered, as long as the concentration of the single isoelectric compound in the hydrogel is higher than what is required to establish a pH in the hydrogel substantially equal to the pI value of the single isoelectric compound.

Preferably, the single isoelectric compound is selected from iminodicarboxylic acids, alkyliminodicarboxylic acids, aryliminodicarboxylic acids, iminooligocarboxylic acids, aminodicarboxylic acids, alkylaminodicarboxylic acids, arylaminodicarboxylic acids, alkylarylaminodicarboxylic acids, aminooligocarboxylic acids, alkylaminooligocarboxylic acids, arylaminooligocarboxylic acids, alkylarylaminooligocarboxylic acids, oligoaminooligocarboxylic acids, iminodiphosphonic acids, alkyliminodiphosphonic acids, aryliminodiphosphonic acids, iminooligophosphonic acids, aminophosphonic acids, alkylaminophosphonic acids, arylaminophosphonic acids, alkylarylaminophosphonic acids, aminodiphosphonic acids, alkylaminodiphosphonic acids, arylaminodiphosphonic acids, alkylarylaminodiphosphonic acids, aminooligophosphonic acids, alkylaminooligophosphonic acids, arylaminooligophosphonic acids, alkylarylaminooligophosphonic acids, oligoaminooligophosphonic acids, aminophenols, aminodiphenols, amino oligophenols, oligoamino oligophenols, iminodiphenols for the preparation of acidic isoelectric hydrogels, or compounds containing combinations of the functional groups thereof.

Preferably, the single isoelectric compound is selected from diaminocarboxylic acids, diaminophenols, diaminophosphonic acids, oligoaminocarboxylic acids, oligoaminophenols, oligoaminophosphonic acids for the preparation of basic isoelectric hydrogels, or compounds containing combinations of the functional groups thereof.

The isoelectric hydrogel materials can be prepared from isoelectric substances having a pI from about 1 to about 12.

In one preferred form, the isoelectric hydrogel materials according to the present invention have a low pI. In another preferred form, the isoelectric hydrogel materials according to the present invention have a medium to high pI. It will be appreciated, however, that isoelectric hydrogels with a wide range of different but discrete pI values can be produced. It should be noted that the pI of the isoelectric hydrogel materials prepared according to the present invention is not continuously tunable but discrete and stable, as long as the concentration of the single isoelectric compound in the hydrogel is higher than what is required to establish a pH in the hydrogel substantially equal to the pI value of the single isoelectric compound.

Preferably, for the preparation of the acidic isoelectric hydrogels, the isoelectric compound is iminodiacetic acid with a pI value of pI<2.5; aspartic acid with a pI value of pI<3 or glutamic acid with a pI value of pI<4.

Preferably, the single isoelectric compound is incorporated into the hydrogel by reacting the compound and one or more of the hydrogel constituents in the presence of a difunctional or oligofunctional agent. Suitable difunctional or oligofunctional agents include, but are not limited to, diepoxides, dihalides, epihalohydrines. It will be appreciated, however, that other difunctional or oligofunctional agents could also be used. The difunctional or oligofunctional agent incorporates the single isoelectric compound into the isoelectric hydrogel via a nitrogen atom (amine group) or an hydroxy group present in the compound.

Preferably, the oligomeric or polymeric scaffold includes, but not limited to, unhydrolyzed or partially hydrolyzed poly(epihalohydrine)s, poly(vinyl alcohol)s and their derivatives, unhydrolyzed or partially hydrolyzed poly(vinyl acetate)s and their derivatives, hydrolyzed or partially hydrolyzed poly(vinyl chloride)s, oligo- and polysaccharides and their derivatives. It will be appreciated, however, that other oligomeric or polymeric scaffolds can also be used for the present invention.

In one preferred form, the hydrolytically stable isoelectric hydrogel material is formed by reacting iminodiacetic acid, poly(vinyl alcohol) and glycerol diglycidyl ether in the presence of NaOH.

In another preferred form, the hydrolytically stable isoelectric hydrogel material is formed by reacting aspartic acid, poly(vinyl alcohol) and glycerol diglycidyl ether in the presence of NaOH.

In another preferred form, the hydrolytically stable isoelectric hydrogel material is formed by reacting glutamic acid, poly(vinyl alcohol) and glycerol diglycidyl ether in the presence of NaOH.

In another preferred form, the hydrolytically stable isoelectric hydrogel material is formed by reacting iminodiacetic acid, poly(vinyl alcohol) and poly(ethylene glycol) diglycidyl ether in the presence of NaOH.

In another preferred form, the hydrolytically stable isoelectric hydrogel material is formed by reacting aspartic acid, poly(vinyl alcohol) and poly(ethylene glycol) diglycidyl ether in the presence of NaOH.

In another preferred form, the hydrolytically stable isoelectric hydrogel material is formed by reacting glutamic acid, poly(vinyl alcohol) and poly(ethylene glycol) diglycidyl ether in the presence of NaOH.

In yet another preferred form, the hydrolytically stable hydrogel material is formed by reacting lysine, poly(vinyl alcohol) and glycerol diglycidyl ether in the presence of NaOH.

In a third aspect, the present invention provides a hydrolytically stable hydrogel membrane comprising a single isoelectric material according to the first or second aspects of the present invention supported on an inert or crosslinkable or crosslinked substrate.

It will be appreciated that the substrate may be made of any suitable material capable of supporting a hydrogel to form a membrane. Preferably, the substrate is selected from, but not limited to, materials made of poly(vinyl alcohol) and its derivatives, partially or fully hydrolysed poly(vinyl acetate) and its derivatives, partially or fully hydrolysed poly(epihalohydrine) and its derivatives, partially or fully hydrolysed poly(epihalohyrine-co-polyethylene oxide) and its derivatives, poly(vinyl chloride) and its derivatives, polyvinylsulfone and its derivatives or polyether ether ketone and its derivatives. It will be appreciated, however, that there would be other substrates suitable for use in the present invention.

In a fourth aspect, the present invention provides a method for forming an hydrolytically stable isoelectric hydrogel material comprising:

reacting a single isoelectric compound having a defined pI with an oligo- or polyhydroxy compound and a difunctional or oligofunctional agent, wherein after incorporation of the single isoelectric compound into the resulting hydrogel, the hydrogel material becomes an ampholytic material.

In a fifth aspect, the present invention provides a method for forming an hydrolytically stable isoelectric hydrogel material comprising:

incorporating or grafting a single isoelectric compound having a defined pI onto an oligomeric or polymeric scaffold that can be subsequently turned into hydrogel and/or membrane, wherein after incorporation or grafting of the single isoelectric compound the hydrogel material becomes an ampholytic material.

In a sixth aspect, the present invention provides a method for forming an hydrolytically stable hydrogel membrane comprising:

carrying out the method according to the fourth or fifth aspects of the present invention; and

applying the isoelectric material onto an inert or crosslinkable or crosslinked supporting substrate to form a hydrolytically stable hydrogel membrane.

In a seventh aspect, the present invention provides an isoelectric hydrogel material produced by the method according to the fifth or sixth aspects of the present invention.

In an eighth aspect, the present invention provides use of a hydrolytically stable hydrogel membrane according to the present invention in the separation of compounds by electrophoresis.

One advantage of the isoelectric hydrogel materials of the present invention is that an isoelectric material can be formed that is stable to breakdown in water or other aqueous environments. Thus, the term hydrolytically stable means that the isoelectric hydrogel materials do not substantially decompose in water.

Another advantage of many of the isoelectric hydrogel materials of the present invention over the Immobiline-chemicals based acrylamido isoelectric hydrogels and cellulose-based isoelectric hydrogels and/or membranes obtained by reacting the polysaccharide by an appropriate weak acid and a weak or strong base or and appropriate weak base and weak or strong acid, is that if the incorporation rate of the single isoelectric substance into the hydrogel is varied, it does not substantially alter the pI value of the hydrogel, only its buffering capacity, as long as the concentration of the single isoelectric compound in the hydrogel is higher than what is required to establish a pH in the hydrogel substantially equal to the pI value of the single isoelectric compound. In contrast, if the incorporation rate of the Immobiline chemicals into the acrylamide hydrogel or extent of grafting of the appropriate weak acid and a weak or strong base or the appropriate weak base and weak or strong acid onto the polysaccharide is varied, both the pI value and the buffering capacity of the hydrogel are altered.

A further advantage of the isoelectric hydrogel materials of the present invention is that high buffering capacity hydrogels can be obtained by incorporation of high concentrations of the single isoelectric material in the hydrogel. Up to about one mole of the single isoelectric compound can be incorporated in the hydrogel for 5 moles of the reactive groups of the oligo- or polyhydroxy compound. In contrast, isoelectric materials presently available such as those produced from acrylamide are hydrolytically unstable at extreme pH values and have lower buffering capacity (up to about one mole of weak or strong electrolyte functional group can be incorporated into the hydrogel for every 10 mole of acrylamide monomer).

A still further advantage of the isoelectric hydrogel materials and membranes of the present invention is that there can be a reduction in the magnitude of electroosmotic flow through such hydrogels and/or membranes.

Throughout this specification, unless the context requires otherwise, the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

Any discussion of documents, acts, materials, devices, articles or the like which has been included in the present specification is solely for the purpose of providing a context for the present invention. It is not to be taken as an admission that any or all of these matters form part of the prior art base or were common general knowledge in the field relevant to the present invention before the development of the present invention.

In order that the present invention may be more clearly understood, preferred forms will be described with reference to the following examples.

### MODE(S) FOR CARRYING OUT THE INVENTION

In membrane-mediated isoelectric focusing and isoelectric trapping separations it is desirable to use hydrolytically stable isoelectric hydrogels and/or membranes that have adequate buffering capacities. These isoelectric hydrogels and/or membranes can serve as anti-convective media, ion-permeable separative barriers or electrode compartment barriers. The isoelectric hydrogels and/or membranes can play multiple roles: they effect or aid the desired separations by their buffering and/or sieving ability and prevent convective mixing. Typically, the ion-permeable barriers, hydrogels and/or membranes are prepared by copolymerizing acrylamide and/or its derivatives with acrylamido weak and/or strong electrolyte derivatives, suitable modifiers and crosslinkers. Though acrylamide-based ion-permeable isoelectric barriers, hydrogels and/or membranes have many outstanding and desirable characteristics, neither the monomers, nor the polymers are hydrolytically stable at extreme pH values, and the pI value of the hydrogels varies unpredictably depending on the individual incorporation rates of the at least two weak acid and weak or strong base or weak base and weak or strong acid constituents.

In addition to the limited hydrolytic stability of the acrylamide-based hydrogels and/or membranes, the formation of low pI isoelectric hydrogels and/or membranes is hindered by the scarcity of acrylamido weak acid derivatives with pKₐ values between 1 and 3. Furthermore, due to synthetic difficulties, the cost of acrylamido weak and/or strong electrolyte derivatives is high, hindering their facile, wide-spread use.

Though the cellulose-based isoelectric membranes obtained by grafting a weak acid and a weak or strong base or a weak base and a weak or strong acid functional group onto the polysaccharide are hydrolytically more stable than the acrylamido derivatives (Immobiline)-based isoelectric hydrogels, they share at least one of the drawbacks of the Immobiline-based membranes, namely that the pI value of the hydrogels varies unpredictably depending on the individual grafting rates of the at least two weak acid and weak or strong base or weak base and weak or strong acid constituents.

It has now been found by the present inventors that it is possible to immobilize in a hydrogel and/or membrane a single hydrolytically stable isoelectric compound that has a high buffering capacity in the vicinity of its pI value, thus it is possible to create a hydrolytically stable hydrogel and/or membrane with a high buffering capacity. The present inventors found that for the formation of acidic isoelectric hydrogels iminodicarboxylic acids, alkyliminodicarboxylic acids, aryliminodicarboxylic acids, iminooligocarboxylic acids, aminodicarboxylic acids, alkylaminodicarboxylic acids, arylaminodicarboxylic acids, alkylarylaminodicarboxylic acids, aminooligocarboxylic acids, alkylaminooligocarboxylic acids, arylaminooligocarboxylic acids, alkylarylaminooligocarboxylic acids, oligoaminooligocarboxylic acids, iminodiphosphonic acids, alkyliminodiphosphonic acids, aryliminodiphosphonic acids, iminooligophosphonic acids, aminophosphonic acids, alkylaminophosphonic acids, arylaminophosphonic acids, alkylarylaminophosphonic acids, aminodiphosphonic acids, alkylaminodiphosphonic acids, arylaminodiphosphonic acids, alkylarylaminodiphosphonic acids, aminooligo phosphonic acids, allylaminooligo phosphonic acids, arylaminooligo phosphonic acids, alkylarylaminooligo phosphonic acids, oligoaminooligophosphonic acids, aminophenols, amino diphenols, amino oligophenols oligoamino oligophenols, and iminodiphenols can be readily incorporated into hydrogels by reacting oligo- and polyhydroxy compounds and the single isoelectric compound with a number of common reagents (difunctional and oligofunctional agents) including, but not limited to, diepoxides, dihalides, epihalohydrines, etc.

The present inventors also found that such single isoelectric compounds can be incorporated into and/or grafted onto suitable oligomeric or polymeric scaffolds that can be subsequently turned into hydrogels and/or membranes including, but not limited to, unhydrolyzed or partially hydrolyzed poly(epihalohydrine)s, poly(vinyl alcohol)s and their derivatives, unhydrolyzed or partially hydrolyzed poly(vinyl acetate)s and their derivatives, hydrolyzed or partially hydrolyzed poly(vinyl chloride)s and their derivatives, oligo- and polysaccharides and their derivatives to anchor the isoelectric groups.

The present inventors have also found that for the preparation of basic isoelectric hydrogels diaminocarboxylic acids, diaminophenols, diaminophosphonic acids, oligoaminocarboxylic acids, oligoaminophenols, and oligoaminophosphic acids can be readily incorporated into hydrogels by reacting oligo- and polyhydroxy compounds and the single isoelectric compound with a number of common reagents (difunctional and oligofunctional agents) including, but not limited to, diepoxides, dihalides, epihalohydrines, etc. The present inventors also found that such single isoelectric compounds can be incorporated into and/or grafted onto suitable oligomeric or polymeric scaffolds that can be subsequently turned into hydrogels and/or membranes including, but not limited to, unhydrolyzed or partially hydrolyzed poly(epihalohydrine)s, poly(vinyl alcohol)s and their derivatives, unhydrolyzed or partially hydrolyzed poly(vinyl acetate)s and their derivatives, hydrolyzed or partially hydrolyzed poly(vinyl chloride)s and their derivatives, oligo- and polysaccharides and their derivatives to anchor the isoelectric groups.

Finally, the present inventors have found that the hydrophilic, polymeric nature of such hydrogels and/or membranes can reduce the magnitude of electroosmotic flow through such hydrogels and/or membranes. This is a very desirable property for many electrophoretic separations.

By varying the concentration of the OH group-containing polymeric material and/or the type and/or the concentration of the crosslinking agent and/or the type and/or the concentration of the single isoelectric compound, the present invention allows production of high buffering capacity isoelectric hydrogels and/or membranes that can also act as sieving matrices in electrophoretic separations, in a way similar to acrylamide-based gels.

In developing the present invention, various hydrogels were prepared at temperatures ranging from room temperature to about 80° C. and reaction times varying from a few minutes to several days. Higher temperatures were used in order for the reaction to proceed at a reasonable rate. It has been found, however, that the actual reaction temperature and time of reaction incubation are not particularly critical to develop various hydrogels according to the present invention. It will be appreciated that as temperatures are elevated, the rate of reaction will increase allowing for the incubation times to be shorter. Accordingly, reaction conditions can be selected in order to determine how long the reaction needs to proceed.

Many additional tasks can be solved utilizing the hydrolytically stable, high buffering capacity isoelectric hydrogel and/or membrane compositions disclosed herein without departing from the essence of this disclosure.

### Apparatus

A membrane-based electrophoresis apparatus particularly suitable for isoelectric focussing or isoelectric trapping has been developed by The Texas A&M University System and Gradipore Limited (WO 02/24314, which is incorporated herein by reference). The apparatus, termed herein as “the Twinflow unit” comprises (a) a first electrolyte reservoir and a second electrolyte reservoir; (b) a first sample reservoir and a second sample reservoir; (c) a separation unit having a first electrolyte chamber in fluid connection with the first electrolyte reservoir, a second electrolyte chamber in fluid connection with the second electrolyte reservoir, a first sample chamber positioned between the first electrolyte chamber and the second electrolyte chamber, a second sample chamber positioned adjacent to the first sample chamber and between the first electrolyte chamber and the second electrolyte chamber, the first sample chamber being in fluid connection with the first sample reservoir, and the second sample chamber being in fluid connection with the second sample reservoir; (d) a first ion-permeable barrier positioned between the first sample chamber and the second sample chamber, the first ion-permeable barrier prevents substantial convective mixing of contents of the first and second sample chambers; (e) a second ion-permeable barrier positioned between the first electrolyte chamber and the first sample chamber, the second ion-permeable barrier prevents substantial convective mixing of contents of the first electrolyte chamber and the first sample chamber; (f) a third ion-permeable barrier positioned between the second sample chamber and the second electrolyte chamber, the third ion-permeable barrier prevents substantial convective mixing of contents of the second electrolyte chamber and the second sample chamber; (g) electrodes positioned in the first and second electrolyte chambers; (h) means for supplying electrolyte from the first electrolyte reservoir to the first electrolyte chamber, and from the second electrolyte reservoir to the second electrolyte chamber; and (i) means for supplying sample or liquid from at least the first sample reservoir to the first sample chamber, or from the second sample reservoir to the second sample chamber.

In use, a sample to be treated is placed in the first and/or second sample reservoirs and provided to, or circulated through, the first and/or second chambers. Electrolyte is placed in the first and second electrolyte reservoirs and passed to, or circulated through, the respective first and second electrolyte chambers without causing substantial mixing between the electrolytes in the two electrolyte reservoirs. Electrolyte or other liquid can be placed in first and/or second sample reservoirs if required. An electric potential is applied to the electrodes wherein one or more components in the first and/or second sample chamber are caused to move through a barrier to the second and/or first sample chamber, or to the first and/or second reservoir chambers. Treated sample or product can be collected in the second and/or first sample reservoir.

### Methods

Weigh a 150 ml beaker. Place the weighed 150 ml beaker and two 230×190×6 mm, clean glass plates into a drying oven at 80° C. Cut a 160×200 mm piece of a Grade BFN 2 Papylon PVA paper (Sansho Co., Ltd, The 2nd Kitahama Building 1-29, Kitaham-Higashi, Chuoh-Ku, Osaka, Japan). Fit a 500 ml, two-neck, round bottom flask with a condenser and an nitrogen purge line. Place a 1″ football-shaped stir bar into the flask. Purge the system with nitrogen. Circulate ice-water through the condenser.

Place the flask into a heating mantle. Put on protective gloves. Add 60 ml deionized water to the flask. Add 6.94 g (0.1735 mol) NaOH to the flask. Add 0.4 g (0.003 mol) iminodiacetic acid (IDA) to the flask. Begin stirring the reaction mixture and heat it to a boil. Add 12 g (0.273 mol OH equivalent) 99% hydrolyzed poly(vinyl alcohol), average molecular weight 89,000-98,000 (PVA) to the flask. Maintain a nitrogen atmosphere over the reaction mixture, continue stirring and heating until PVA is completely dissolved. Turn off the heating mantle.

Take the hot, bottom glass plate from the oven and place it onto a layer of paper towels. Take the hot, 150 ml beaker from the oven and weigh into it a 60 g aliquot of the hot, viscous reaction mixture. Quickly add to it 5.1 ml (6.268 g, 0.031 mol) glycerol diglycidyl ether and mix it well (manually) with a spatula. Pour half of the beaker's content onto the hot, bottom glass plate and quickly distribute the mixture over the plate by tilting it around. Lower the BFN 2 Papylon PVA substrate onto the reaction mixture and saturate the substrate with the reaction mixture.

Take the hot, cover glass plate from the oven, pour the second half of the reaction mixture from the beaker onto it and quickly distribute the mixture over the plate by tilting it. Lower the coated face of the cover plate onto the BFN 2 Papylon PVA substrate and press the plate to evenly distribute the reaction mixture over the entire surface of the BFN 2 Papylon PVA substrate. Place two 16×16×2″ cement patio paving stones onto the glass plates to compress them and squeeze out the excess reaction mixture.

Two hours later, remove the paving stones from the glass plates. Let the glass plate mold stand undisturbed at room temperature for at least 38 hours (total curing time at least 40 hours).

Fill a 16×12×6″ polypropylene tub with deionized water. Using a razor blade, cut along all four edges of the glass plate mold to remove the solidified, spilled-out reaction mixture. Lower the mold into the deionized water in the tub. Gently pull the glass plates apart under water. The membrane should slip off easily from the glass plates. Gently slosh around the membrane in the rinse water for about five minutes. Replace the rinse water, slosh around the membrane for another five minutes. Repeat the procedure at least five times. Test the pH of the last wash water: it should be around neutral. The salvage edge of the membrane should be clear, transparent, the surface of the membrane strong, even and slippery.

Store the membrane in deionized water in the fridge until used. The membrane will swell to a final thickness of about 0.2 to 2 mm, depending on the amount of reaction mixture left on the BFN 2 Papylon PVA substrate. The residual reactivity of the membrane due to left-over epoxide groups is unknown at the present time, so handle the membrane with care, wearing gloves. Using scissors, cut the membrane to size to fit the separation cartridge of the Twinflow unit. Punch inlet and outlet holes into the membrane and assemble the cartridge. Leak test the assembled cartridge in the Twinflow, then commence the IET separation. After use, rinse the membrane and dispose it as solid waste.

### EXPERIMENTAL

The feasibility of creating hydrolytically stable low-pI hydrogels and/or membranes as outlined above has been experimentally demonstrated as follows.

### Experiment 1

Low-pI, clear hydrogels were prepared by reacting iminodiacetic acid, poly(vinyl alcohol) and glycerol diglycidyl ether in the presence of NaOH, at 80° C.

### Experiment 2

Low-pI, clear hydrogels were prepared by reacting iminodiacetic acid, poly(vinyl alcohol) and glycerol diglycidyl ether in the presence of NaOH, at 60° C.

### Experiment 3

Low-pI, clear hydrogels were prepared by reacting glutamic acid, poly(vinyl alcohol) and glycerol diglycidyl ether in the presence of NaOH, at 60° C.

### Experiment 4

Low-pI, clear hydrogels were prepared by reacting aspartic acid, poly(vinyl alcohol) and glycerol diglycidyl ether in the presence of NaOH, at 60° C.

### Experiment 5

Low-pI, high buffering capacity isoelectric membranes were prepared by casting, in a glass mold, an 80° C. reaction mixture of iminodiacetic acid, poly(vinyl alcohol), glycerol diglycidyl ether and NaOH over a Papylon Grade 3 poly(vinyl alcohol) substrate and reacting the mixture at 60° C. for 12 hours.

### Experiment 6

The high buffering capacity, low-pI membranes prepared in Experiment 5 were successfully tested as the anodic membrane in a membrane-based electrophoresis apparatus (called herein a “Twinflow unit”) in single separation compartment configuration. The cathodic membrane was a hydrolytically stable, pI>12 isoelectric membrane prepared from trimethylammonio β-cyclodextrin, poly(vinyl alcohol) and glycerol diglycidyl ether. The anolyte was 990 mM methanesulfonic acid and 10 mM benzenesulfonic acid, the catholyte 990 mM NaOH and 10 mM benzyltrimethylammonium hydroxide, the separation compartment contained tyramine (TYRA, approximate pI=10), histidine (HIS, pI=7.5) and meta-aminobenzoic acid (MABA, approximate pI=3.9) as analytes. Leak-free seal was achieved in the system, and MABA, HIS and TYRA were trapped for the duration of the 180 min run.

### Experiment 7

Low-pI, clear hydrogels were prepared by reacting iminodiacetic acid, poly(vinyl alcohol) and glycerol diglycidyl ether in the presence of NaOH, at room temperature for 48 hours.

### Experiment 8

Low-pI, high buffering capacity isoelectric membranes were prepared by casting, in a glass mold, an 80° C. reaction mixture of iminodiacetic acid, poly(vinyl alcohol), glycerol diglycidyl ether and NaOH over a Papylon Grade BFN 3 poly(vinyl alcohol) substrate and reacting the mixture at room temperature for 40 hours.

### Experiment 9

The high buffering capacity low-pI membranes prepared in Experiment 8 were successfully tested as the anodic membrane in the Twinflow unit, in single separation compartment configuration. The cathodic membrane was a hydrolytically stable, pI>12 isoelectric membrane prepared from glycidyl trimethylammonium chloride, poly(vinyl alcohol) and glycerol diglycidyl ether. The anolyte was 950 mM methanesulfonic acid and 50 mM benzenesulfonic acid, the catholyte 950 mM NaOH and 50 mM benzyltrimethylammonium hydroxide, the separation compartment contained TYRA (pI=10), HIS (pI=7.5) and MABA (pI=3.9) as analytes. Leak-free seal was achieved, and MABA, HIS and TYRA were trapped for the duration of the 180 min run.

### Experiment 10

Low-pI, high buffering capacity isoelectric membranes were prepared by casting, in a glass mold, an 80° C. reaction mixture of iminodiacetic acid, poly(vinyl alcohol), glycerol diglycidyl ether and NaOH over a Papylon Grade BFN 2 poly(vinyl alcohol) substrate and reacting the mixture at room temperature for 40 hours.

### Experiment 11

The high buffering capacity low-pI membranes prepared in Experiment 10 were successfully tested as the anodic membrane in the Twinflow unit, in single separation compartment configuration. The cathodic membrane was a hydrolytically stable, pI>12 isoelectric membrane. The separation compartment contained TYRA (pI=10), HIS (pI=7.5), MABA (pI=3.9), aspartic acid (Asp, approximate pI=2.7) and iminodiacetic acid (IDA, approximate pI=2.3) as analytes. Leak-free seal was achieved, and all compounds were trapped for the duration of the 180 min run.

### Experiment 12

The high buffering capacity low-pI membranes prepared according to Experiment 10 were used as anodic membranes in over 10 isoelectric trapping (IET) separations. Each time, when the methansulfonic acid concentration in the anolyte was higher than 60 mM and the IET current was sufficiently high (>200 mA), the membranes functioned satisfactorily.

### Experiment 13

High-pI, clear hydrogels were prepared by reacting lysine, poly(vinyl alcohol) and glycerol diglycidyl ether in the presence of NaOH, at room temperature for 48 hours.

### SUMMARY

The new compositions according to the present invention allow the preparation of hydrolytically and mechanically stable, high buffering capacity, hydrogels and/or membranes that were not available prior to this work. The invention is aimed to address the worst shortcoming of the currently used isoelectric hydrogels and/or membranes, such as Immobiline chemicals-based acrylamide hydrogels and membranes and cellulose-based hydrogels and membranes to which an appropriate weak acid and weak or strong base or an appropriate weak base and weak or strong acid are grafted, namely their limited hydrolytic stability in extreme pH environments, and the unpredictable variation of their pI value that is caused by the incomplete incorporation of the Immobiline chemicals.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

1. A hydrolytically stable isoelectric hydrogel material formed by mixing and/or reacting a mixture comprising an oligo- or polyhydroxy compounds, a single isoelectric compound having a pI value of from 1 to 12, and a difunctional or oligofunctional agent, whereby after said mixed and/or reacting the hydrolytically stable isoelectric hydrogel material formed becomes an ampholytic material.

2. The hydrolytically stable isoelectric hydrogel material according to claim 1, wherein said hydrolytically stable isoelectric hydrogel material has a pI value which does not substantially change when the amount of the isoelectric compound mixed and/or reacted is altered, with the proviso that the concentration of the single isoelectric compound mixed and/or reacted is higher than the concentration of the single isoelectric compound mixed and/or reacted that is required to establish a pH in the hydrolytically stable isoelectric hydrogel material which is substantially equal to the pI value of the single isoelectric compound.

3. The hydrolytically stable isoelectric hydrogel material according to claim 1 wherein the single isoelectric compound mixed and/or reacted is selected from the group consisting of iminodicarboxylic acids, alkyliminodicarboxylic acids, aryliminodicarboxylic acids, iminooligocarboxylic acids, aminodicarboxylic acids, alkylaminodicarboxylic acids, arylaminodicarboxylic acids, alkylarylaminodicarboxylic acids, aminooligocarboxylic acids, alkylaminooligocarboxylic acids, arylaminooligocarboxylic acids, alkylarylaminooligocarboxylic acids, oligoaminooligocarboxylic acids, iminodiphosphonic acids, alkyliminodiphosphonic acids, aryliminodiphosphonic acids, iminooligophosphonic acids, aminophosphonic acids, alkylaminophosphonic acids, arylaminophosphonic acids, alkylaryiaminophosphonic acids, aminodiphosphonic acids, alkylaminodiphosphonic acids, arylaminodiphosphonic acids, alkylarylaminodiphosphonic acids, aminooligophosphonic acids, alkylaminooligophosphonic acids, arylaminooligophosphonic acids, alkylarylaminooligophosphonic acids, oligoaminooligophosphonic acids, aminophenols, aminodiphenols, amino oligophenols, oligoamino oligophenols, iminodiphenols, and compounds containing combinations of the functional groups thereof.

4. The hydrolytically stable isoelectric hydrogel material according to claim 3 wherein the single isoelectric compound mixed and/or reacted is selected from the group consisting of iminodiacetic acid with a pI value of pI<2.5, aspartic acid with a pI value of pI<3, and glutamic acid with a pI value of pI<4.

5. The hydrolytically stable isoelectric hydrogel material according to claim 1 wherein the single isoelectric compound mixed and/or reacted is selected from the group consisting of diaminocarboxylic acids, diaminophenols, diaminophosphonic acids, oligoaminocarboxylic acids, oligoaminophenols, oligoaminophosphonic, and compounds containing combinations of the functional groups thereof.

6. (canceled)

7. The hydrolytically stable isoelectric hydrogel material according to claim 1 wherein the difunctional or oligofunctional agent mixed and/or reacted is selected from the group consisting of diepoxides, dihalides, and epihalohydrines.

8. An hydrolytically stable isoelectric hydrogel material formed by mixing and/or reacting a mixture comprising an isoelectric compound having a pI of from 1 to 12 and an oligomeric or polymeric scaffold, wherein the hydrolytically stable isoelectric hydrogel material formed thereby can be subsequently turned into an hydrogel and/or a membrane, and whereby after said mixing and/or reacting the hydrolytically stable hydrogel material becomes an ampholytic material.

9. The hydrolytically stable isoelectric hydrogel material according to claim 8, wherein said hydrolytically stable isoelectric hydrogel material has a pI value which does not substantially change when the amount of the isoelectric compound mixed and/or reacted is altered, with the proviso that the concentration of the single isoelectric compound mixed and/or reacted is higher than the concentration of the single isoelectric compound mixed and/or reacted that is required to establish a pH in the hydrolytically stable isoelectric hydrogel which is substantially equal to the pI value of the single isoelectric compound.

10. The hydrolytically stable isoelectric hydrogel material according to claim 8 wherein the single isoelectric compound reacted is selected from the group consisting of iminodicarboxylic acids, alkyliminodicarboxylic acids, aryliminodicarboxylic acids, iminooligocarboxylic acids, aminodicarboxylic acids, alkylaminodicarboxylic acids, arylaminodicarboxylic acids, alkylarylaminodicarboxylic acids, aminooligocarboxylic acids, alkylaminooligocarboxylic acids, arylaminooligocarboxylic acids, alkylarylaminooligocarboxylic acids, oligoaminooligocarboxylic acids, iminodiphosphonic acids, alkyliminodiphosphonic acids, aryliminodiphosphonic acids, iminooligophosphonic acids, aminophosphonic acids, alkylaminophosphonic acids, arylaminophosphonic acids, alkylarylaminophosphonic acids, aminodiphosphonic acids, alkylaminodiphosphonic acids, arylaminodiphosphonic acids, alkylarylaminodiphosphonic acids, aminooligophosphonic acids, alkylaminooligophosphonic acids, arylaminooligophosphonic acids, alkylarylaminooligophosphonic acids, oligoaminooligophosphonic acids, aminophenols, aminodiphenols, amino oligophenols, oligoamino oligophenols, iminodiphenols, and compounds containing combinations of the functional groups thereof.

11. The hydrolytically stable isoelectric hydrogel material according to claim 10 wherein the single isoelectric compound mixed and/or reacted is selected from the group consisting of iminodiacetic acid with a pI value of pI<2.5, aspartic acid with a pI value of pI<3, and glutamic acid with a pI value of pI<4.

12. The hydrolytically stable isoelectric hydrogel material according to claim 8 wherein the isoelectric compound mixed and/or reacted is selected from the group consisting of diaminocarboxylic acids, diaminophenols, diaminophosphonic acids, oligoaminocarboxylic acids, oligoaminophenols, oligoaminophosphonic, and compounds containing combinations of the functional groups thereof.

13. The hydrolytically stable isoelectric hydrogel material according to claim 8 wherein the oligomeric or polymeric scaffold mixed and/or reacted is selected from the group consisting of unhydrolyzed or partially hydrolyzed poly(epihalohydrine)s, poly(vinyl alcohol)s and their derivatives, unhydrolyzed or partially hydrolyzed poly(vinyl acetate)s and their derivatives, hydrolyzed or partially hydrolyzed poly(vinyl chloride)s, oligo- and polysaccharides and their derivatives.

14. The hydrolytically stable isoelectric hydrogel material according to claim 8 formed by reacting iminodiacetic acid, poly(vinyl alcohol) and glycerol diglycidyl ether in the presence of NaOH.

15. The hydrolytically stable isoelectric hydrogel material according to claim 8 formed by reacting aspartic acid, poly(vinyl alcohol) and glycerol diglycidyl ether in the presence of NaOH.

16. The hydrolytically stable isoelectric hydrogel material according to claim 8 formed by reacting glutamic acid, poly(vinyl alcohol) and glycerol diglycidyl ether in the presence of NaOH.

17. The hydrolytically stable isoelectric hydrogel material according to claim 8 formed by reacting iminodiacetic acid, poly(vinyl alcohol) and poly(ethylene glycol) diglycidyl ether in the presence of NaOH.

18. The hydrolytically stable isoelectric hydrogel material according to claim 8 formed by reacting aspartic acid, poly(vinyl alcohol) and poly(ethylene glycol) diglycidyl ether in the presence of NaOH.

19. The hydrolytically stable isoelectric hydrogel material according to claim 8 formed by reacting glutamic acid, poly(vinyl alcohol) and poly(ethylene glycol) diglycidyl ether in the presence of NaOH.

20. The hydrolytically stable isoelectric hydrogel material according to claim 8 formed by reacting lysine, poly(vinyl alcohol) and glycerol diglycidyl ether in the presence of NaOH.

21. A hydrolytically stable hydrogel membrane comprising an hydrolytically stable isoelectric material according to claim 1 supported on an inert or crosslinkable or crosslinked substrate.

22. The hydrolytically stable hydrogel membrane according to claim 21 wherein the substrate is selected from the group consisting of materials made of poly(vinyl alcohol) and its derivatives, partially or fully hydrolysed poly(vinyl acetate) and its derivatives, partially or fully hydrolysed poly(epihalohydrine) and its derivatives, partially or fully hydrolysed poly(epihalohyrine-co-polyethylene oxide) and its derivatives, poly(vinyl chloride) and its derivatives, polyvinylsulfone and its derivatives, and polyether ether ketone and its derivatives.

23. A method for forming an hydrolytically stable isoelectric hydrogel material comprising:
mixing and/or reacting a single isoelectric compound having a pI of 1 to 12 with a mixture comprising an oligo- or polyhydroxy compound and a difunctional or oligofunctional agent, wherein after said mixing and/or reacting, the hydrolytically stable isoelectric hydrogel material formed thereby becomes an ampholytic material.

24. A method for forming an hydrolytically stable isoelectric hydrogel material comprising:
mixing and/or reacting a mixture comprising a single isoelectric compound having a pI of 1 to 12 with an oligomeric or polymeric scaffold, wherein the oligomeric or polymeric scaffold can be subsequently turned into a hydrogel and/or membrane, and whereby after said mixing and/or reacting, the hydrolytically stable isoelectric hydrogel material becomes an ampholytic material.

25. A method for forming an hydrolytically stable hydrogel membrane comprising:
applying a hydrolytically stable isoelectric material prepared by the method according to claim 23 onto an inert or crosslinkable or crosslinked supporting substrate.

26. (canceled)

27. A method of separating compounds by electrophoresis comprising introducing a mixture of compounds into a membrane-based electrophoresis apparatus comprising an anodic and/or cathodic membrane according to claim 21.
